(19) United States
(12) Patent Application Publication
(10) Pub. No.: US 2026/0163156 A1
(43) Pub. Date: Jun. 11, 2026

(54) Battery Pack; Contact Device for a Battery Pack

(71) Applicant: Robert Bosch GmbH, Stuttgart (DE)

(72) Inventors: Jannik Renfordt, Grossbettlingen (DE); Juergen Kurle, Reutlingen (DE); Simon Buck, St. Johann (DE); Tobias Thiel, Reutlingen (DE)

(21) Appl. No.: 19/177,592

(22) Filed: Apr. 13, 2025

(30) Foreign Application Priority Data
Apr. 26, 2024 (DE) 10 2024 203 932.2

(51) Int. Cl. H01M 50/249; B62J 43/20; H01M 50/262; H01M 50/284; H01M 50/516

(52) U.S. Cl. CPC H01M 50/249; B62J 43/20; H01M 50/262; H01M 50/284; H01M 50/516; H01M 2220/20

(57) ABSTRACT

A rechargeable battery pack, in particular a replaceable rechargeable battery pack, includes (i) an electrical interface for the detachable connection of the rechargeable battery pack to a consumer, in particular to an electric bike, (ii) an electronic system that has at least one printed circuit board, and (iii) a contact device that has at least one contact element designed to connect the electrical interface of the rechargeable battery pack to the electronic system of the rechargeable battery pack. At least one contact element can be electrically connected to the electrical interface via at least one connecting element, in particular a cable element.

This application claims priority under 35 U.S.C. § 119 to application no. DE 10 2024 203 932.2, filed on Apr. 26, 2024 in Germany, the disclosure of which is incorporated herein by reference in its entirety.

### BACKGROUND

DE 10 2022 211 713 A1 describes a battery pack with an electronic system that is connected to a plug.

### SUMMARY

The disclosure relates to a rechargeable battery pack, in particular a replaceable rechargeable battery pack, with an electrical interface for the detachable connection of the rechargeable battery pack to a consumer, in particular to an electric bike, with an electronic system that has at least one printed circuit board, and with a contact device that has at least one contact element designed to connect the electrical interface of the rechargeable battery pack to the electronic system of the rechargeable battery pack. It is suggested that at least one contact element can be electrically connected to the electrical interface via at least one connecting element, in particular a cable element. This can be used to advantage to provide a battery pack with an optimized and secure connection of the electrical interface to the electronic system.

In the context of this application, an electric bike is in particular understood to mean a bike which comprises a drive unit for assisting the rider. The electric bike is preferably designed as an e-bike, a pedelec, an S-pedelec, a cargo bike, a folding bike or the like. The drive unit comprises a motor which can, e.g., be designed as a mid-drive motor or as a hub motor. The motor is preferably designed as an electric motor. The drive unit is connected to the battery pack to supply the drive unit with energy. The battery pack has a battery housing that is preferably detachably connected to a housing of the consumer, in particular to a frame of the electric bike. The electric bike preferably has a control unit, wherein the control unit of the electric bike is assigned to the electronic system.

The electronic system preferably comprises a sensor unit, where the sensor unit may comprise, for example, motion sensors, torque sensors, speed sensors, GNSS receivers, magnetic sensors or the like. In addition, the electronic system in particular comprises at least one communication interface for wireless connection of the electric bike to the mobile terminal and/or a server. The communication interface can be designed, for example, as a short-range communication interface, in particular as a Bluetooth interface or as a WiFi interface, for connecting to the mobile terminal device.

Alternatively, the consumer can also be designed as another electric light vehicle, for example as an eScooter or as an electric motorcycle. It is also conceivable that the consumer is designed as a garden tool, a household appliance or a hand-held power tool.

The exchangeable battery pack is preferably designed to be detachable from the consumer without tools. Alternatively, it is also conceivable that the battery pack is permanently attached to or integrated into the housing of the electric bike. In this context, the expression “detachment without tools” is also understood to mean detachment via a lock, e.g. a bike lock. The lock can in this case be designed to be actuatable, e.g. via a key or an electrical actuator. The battery pack is in particular designed to be connectable to a charging apparatus for charging the battery pack. Alternatively or additionally, the battery pack can also be designed in such a way that it can be charged when connected to the electric bike.

The battery pack comprises a housing in particular. At least one battery cell is arranged in the housing of the battery pack. The housing of the battery pack is preferably designed as an outer housing. The battery pack, in particular the battery pack housing, can be designed so that it can be connected or is permanently connected to the consumer, in particular to the electric bike, and/or to a charging device via a mechanical interface. The housing preferably comprises at least one housing portion, which is designed as an outer housing portion. The outer housing portion delimits the battery pack in an outward direction and can be touched by a user.

The battery pack is designed to be electrically connectable to the consumer via the electrical interface. The battery pack can, e.g., be charged and/or discharged via the electrical connection. Alternatively or additionally, it is also conceivable that information from the battery pack be communicable to the consumer via the electrical interface, and vice versa. The consumer or the charger has an electrical interface corresponding to the electrical interface of the battery pack.

The electrical interface is preferably designed as a contact interface, where the electrical connection occurs via a physical contact of at least two conductive components. The electrical interface preferably comprises at least two electrical contact elements. In particular, one of the electrical contact elements is designed as a positive contact, and the other electrical contact element is designed as a negative contact. In addition, the electrical interface can have at least one additional contact that is designed to transmit additional information to the electric bike and/or the charging device. The additional contacts can be designed as signal contacts, coding contacts, temperature contacts, bus contacts, etc. The electrical contact elements can, e.g., be designed as spring contact elements in the form of contact tulips or as flat contacts in the form of contact blades. Alternatively or additionally, the electrical interface can comprise a secondary charging coil element for inductive charging. The mechanical interface and the electrical interface can be designed to be integrated or separate from one another.

The electronic system of the battery pack may comprise a circuit board, a processor, a control unit, a transistor, a capacitor, and/or a storage unit. Additionally, or alternatively, it is also conceivable that information be determined by the electronic system. The electronic system is designed to control or regulate the battery pack and/or the consumer. In particular, the electronic system comprises a BMS (battery management system) designed to monitor the battery pack. In particular, the BMS is designed to prevent overcharging and/or deep discharge of the battery pack. The BMS is preferably designed to correctly balance cells. The electronic system can also comprise one or more sensor elements, e.g. a temperature sensor, for determining the temperature within the battery pack, or a motion sensor for determining movements. The electronic system can alternatively or additionally comprise a coding element, e.g. a coding resistor. In the context of the present application, a printed circuit board is intended to be a circuit board comprising an organic or inorganic substrate, e.g. IMS. The printed circuit board can be designed as a rigid printed circuit board or a flexible printed circuit board. In addition, the printed circuit board can be a populated or an unpopulated printed circuit board. The printed circuit board can comprise a single layer or be designed in multiple layers.

A battery cell can be designed as a galvanic cell which has a structure in which one cell pole comes to lie at one end and a further cell pole comes to lie at an opposite end. In particular, the energy storage cell has a positive cell pole on one end face and a negative cell pole on the opposite end face. Preferably, the battery cells are designed as NiCd or NiMh, particularly preferably as lithium-based battery cells or Li-ion battery cells. Alternatively, it is also conceivable that, by way of example, the battery cell be designed as a pouch cell or as a prismatic cell. The battery voltage of the battery pack is typically a multiple of the voltage of a single battery cell and results from the circuit (parallel or serial) of the battery cells. In common battery cells with a cell voltage of 3.6 V, voltage classes of, by way of example, 3.6 V, 7.2 V, 10.8 V, 14.4 V, 18 V, 36 V, 54 V, 108 V etc., are therefore produced. A battery cell is preferably designed as an at least substantially cylindrical round cell, wherein the cell poles are arranged at the ends of the cylindrical shape.

The contact element of the contact device is designed to electrically connect the contact device to the printed circuit board. The contact element is designed as an electrical contact element and is therefore made of an electrically conductive material. Preferably, the contact element is made of a metal, for example steel, aluminum or copper. The contact element can be designed as a single piece, a single part or multiple parts. In the context of this application, the term “single-piece” is used to refer in particular to a component that is formed from a single piece and thus from a single material. In the context of this application, the term “one-piece” is to be understood in particular to mean components that may also consist of several parts, wherein these are connected to each other via a material bond in such a way that they are essentially inseparable and cannot be detached from each other without being destroyed.

Furthermore, it is proposed that the contact element has a first connection area for connection to the connecting element and a second connection area for connection to the electronic system, in particular for connection to the printed circuit board. The connecting areas are preferably made of the same material. Alternatively, it would also be conceivable for the connecting areas to be made of different materials. The connecting areas may have surface modifications or surface markings to support the connection, for example at least one or more projections in the case of a welded connection. The connecting areas of the contact element can be arranged adjacent to each other or on different sides of the contact element.

Furthermore, it is proposed that the battery pack has at least one battery cell and at least one cell connector, wherein the battery cell is connected to the electronic system via the cell connector. The cell connector can be made of a metal sheet, a cable or a wire, for example. Preferably, the cell connector is formed from a metal sheet, with the cell connector partially or essentially completely covering at least one battery cell, preferably several battery cells, on the front side. The cell connectors are preferably designed in one piece or in several pieces. The cell connectors are preferably made of aluminum, copper or nickel or an alloy of at least one of these materials. The cell connector can also be made of the same material as the contact element of the contact device.

It is also proposed that the contact element and the cell connector be connected to the printed circuit board using the same connection technology. This can advantageously reduce the complexity of the assembly and improve the connection of the components. The connection technique can be, for example, a soldering technique or a welding technique, in particular a resistance welding method or a laser welding method.

Furthermore, it is suggested that the contact element and the cell connector are arranged adjacent to each other on the printed circuit board of the electronic system. This can further optimize assembly. In particular, the contact element of the contact device and the cell connector connected to the rechargeable battery cell are arranged on the same side of the printed circuit board and connected to the printed circuit board.

It is also proposed that the contact elements be connected to a base body of the contact device in a form-fitting manner. This can be used to advantage to provide secure fastening of the contact elements. The base body can be designed as a single piece, a one-piece body or a multi-piece body. The base body is preferably made of a plastic, in particular a hard plastic. Alternatively, it would also be conceivable for the contact element to be connected to the base body by way of a frictional or material bond.

Furthermore, it is proposed that the contact elements have an assembly aid, which is designed to deform the contact elements during the assembly process. This can be beneficial for further optimizing the assembly process. The assembly aid can, for example, be designed as a marking indicating an assembly intervention or as a material weakening.

Furthermore, it is proposed that the contact device has at least one holding element for holding the at least one cable element. This can be advantageous to ensure that the cable element is properly positioned and to avoid cable breakage. The holding element can, for example, be designed to connect the base body to the cable element in a force-fitting and/or form-fitting manner. The holding element can be designed as a single piece or as an integral part of the base body of the contact device. The holding element can be rigid or movable relative to the base body.

In addition, the disclosure relates to a contact device for a battery pack, in particular an exchangeable battery pack, having at least one contact element that is designed to connect an electrical interface of the battery pack to an electronic system of the battery pack, wherein the contact elements can be electrically connected to the electrical interface via at least one cable element. It is proposed that the contact device has at least one holding element for holding the at least one cable element. This can be advantageous to ensure that the cable element is properly positioned and to avoid cable breakage.

Furthermore, it is suggested that the holding element is designed as a latching mechanism. This can be advantageous for enabling a simple and detachable fixation.

Furthermore, it is proposed that the contact device has at least one guide element for guiding the connecting element. This can be used to further optimize the positioning and protection of the cable element.

### BRIEF DESCRIPTION OF THE DRAWINGS

Further advantages follow from the description of the drawings below. The drawings, the description, and the claims contain numerous features in combination. A person skilled in the art will appropriately also consider the features individually and combine them into additional advantageous combinations.

The figures show:

FIG. 1 a perspective view of an electric bike comprising a battery pack according to the disclosure;

FIG. 2 a perspective view of a battery pack for the electric bike shown in FIG. 1;

FIG. 3 a perspective view of a contact device for the battery pack according to FIG. 2;

FIG. 4 a partial perspective view of the battery pack according to FIG. 2 without the housing.

### DETAILED DESCRIPTION

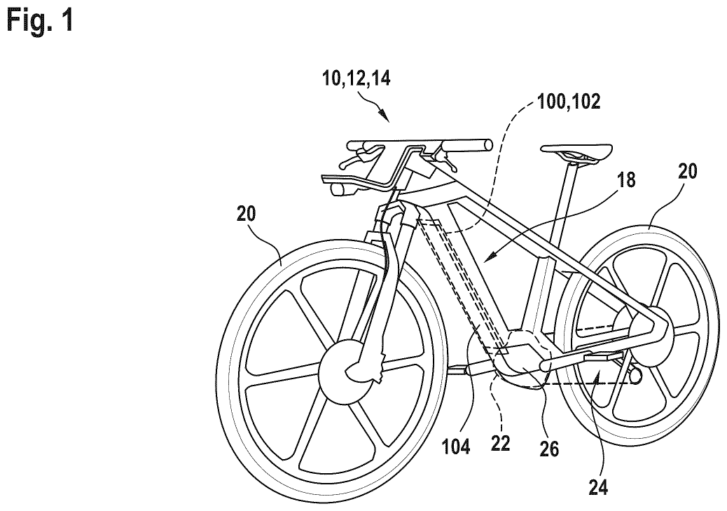

FIG. 1 shows a consumer 10 with a power supply device 100 in the form of a battery pack 102 in a perspective view. The consumer 10 is exemplarily designed as an electrically driven way of transportation 12, in particular as an electric bike 14. The electric bike 14 can, e.g., be designed as a pedelec or an e-bike.

The electric bike 14 comprises a frame 18 or a bike frame. Two wheels 20 are connected to the frame 18. The consumer 10 also comprises a drive unit 22 having an electric motor. The electric motor is preferably designed as a permanent magnet-excited, brushless DC motor. The electric motor is, e.g., designed, as a mid-drive motor, wherein a hub motor or the like is also conceivable.

The drive unit 22 comprises a control unit (not shown) designed to control or regulate the electric bike 14, in particular the electric motor. The electric bike 14 comprises a pedal crank 24. The pedal crank 24 is connected to a pedal crankshaft (not shown).

The control unit and the drive unit 22 comprising the electric motor and the pedal crankshaft are arranged within a drive housing 26 connected to the frame. The drive movement of the electric motor is preferably transmitted to the pedal crankshaft via a transmission (not shown), wherein the magnitude of the assistance by the drive unit 22 is controlled or regulated via the control unit.

The electric bike 14 is electrically and mechanically connected to the battery pack 102, which is designed to supply power to the drive unit 22. The battery pack 102 is designed as an exchangeable battery pack by way of example. The battery pack 102 is exemplarily completely accommodated in the frame 18 of the electric bike 14 when connected. The connection can be made by inserting the battery pack 102 axially into the down tube of the frame 18 or by swiveling the battery pack 102 laterally into the frame 18. Alternatively, it is also conceivable that the battery pack 102 is designed in such a way that the battery pack 102 can be attached to an outer side of the frame 18.

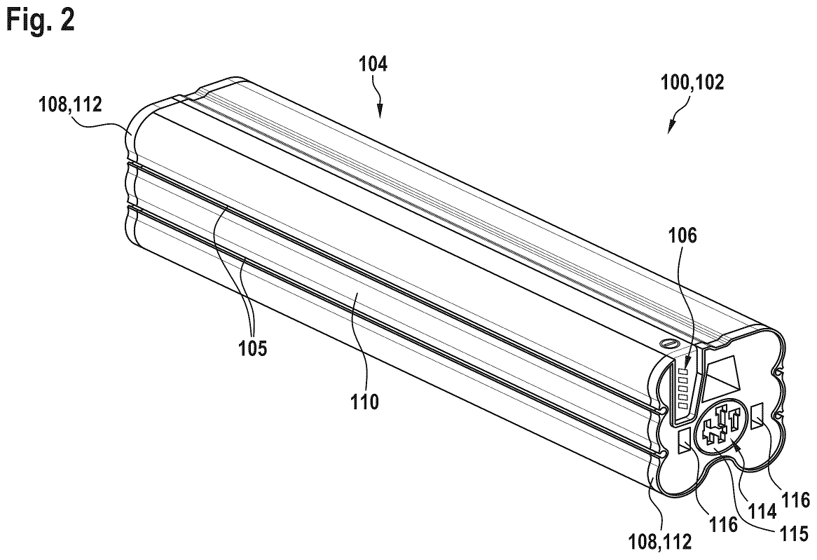

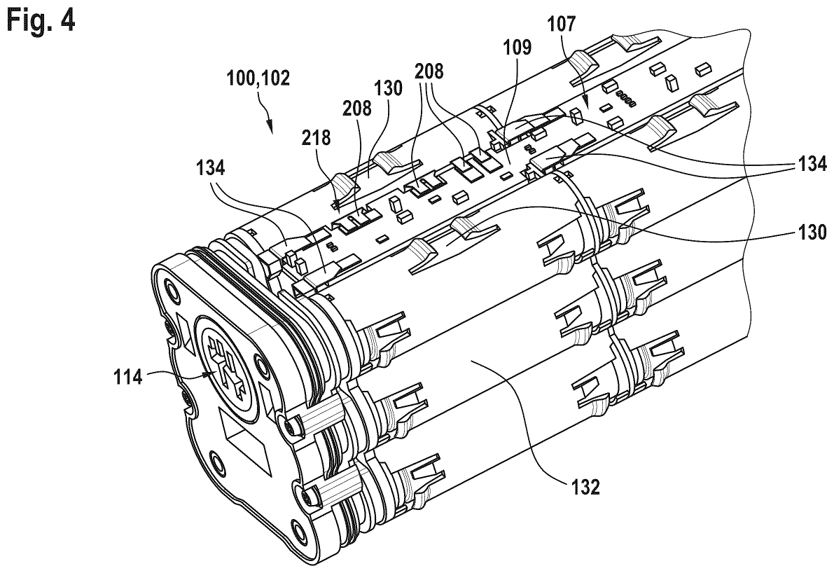

The battery pack 102 is shown in FIG. 2 in a perspective view. The battery pack 102 has a housing 104, in which 20 battery cells 130 (see FIG. 4) are arranged as an example. The housing 104 is exemplarily designed in several parts and comprises a tubular base body 110, which exemplarily is formed by a metal part. At the front, the housing 104 has two end plates 108, which are designed as connection plates 112 and each have at least one connecting element 116. The connecting elements 116 are assigned to a mechanical interface of the battery pack 102, which is designed for the mechanical connection of the battery pack 102 to the electric bike 14. The connecting elements 116 are exemplarily formed as recesses in the connection plate 112, in which a corresponding connecting element, not shown, of the electric bike 14 can engage. The tubular base body 110 also has two longitudinal grooves 105 on each of its side surfaces, which can also be assigned to the mechanical interface, for example, or can be used to connect to a cover, for example.

In addition, the battery pack 102 has a charge level indicator 106. The charge level indicator 106 is connected to an electronic system 107 (see FIG. 4) of the battery pack 102, which is arranged in the housing 104 of the battery pack 102. The charge level indicator 106 can be operated by the user at the push of a button or can be automatically operated, for example by activating the electronic system based on a signal from a motion sensor.

Furthermore, the battery pack 102 comprises an electrical interface 114 for the electrical connection of the battery pack 102 to the electric bike 14. The electrical interface 114 is designed as a socket 115 by way of example. The electrical interface 114 comprises, for example, four electrical contact elements, with two electrical contact elements being designed as power contacts and at least one electrical contact element being designed to exchange information between the battery pack 102 and the electric bike 14.

The electronic system 107 of the battery pack 102 is assigned a control unit with a monitoring system, for example a BMS, for monitoring the battery pack 102, in particular the battery cells 130. The battery cells 130 are monitored with regard to their voltage by way of a single-cell monitor and their temperature by way of a temperature sensor (not shown). The electronic system 107 of the battery pack 102 is connected to the electronic system or the control unit of the electric bike 14 via the electrical interface 114.

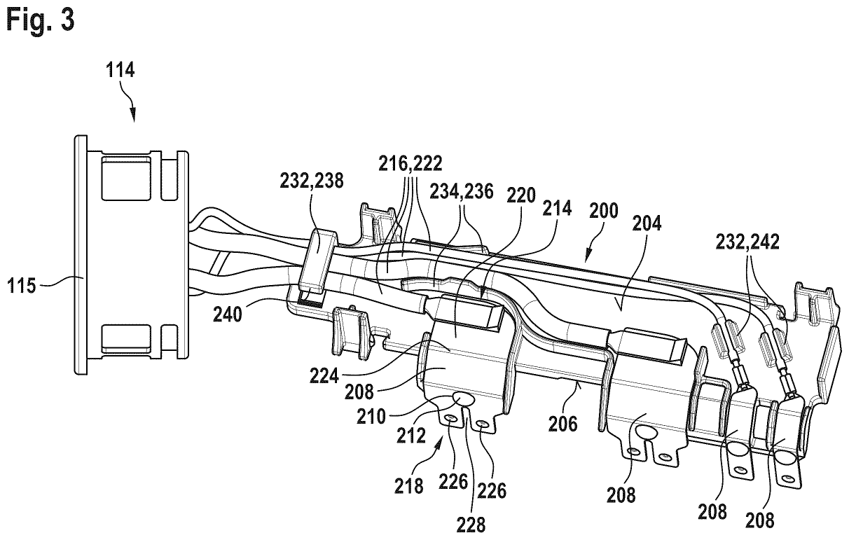

To connect the electrical interface 114 to the electronic system 107, the battery pack 102 has a contact device 200, which is shown in FIG. 3 in a perspective view.

The contact device 200 has a base body 202, which is exemplarily made of a plastic, in particular a hard plastic. The base body 202 is, for example, essentially plate-shaped and has a top side 204 and an underside 206.

The contact device 200 comprises, for example, four contact elements 208 which are designed to electrically connect the contact device 200 to the electronic system 107 of the battery pack 102. The number of contact elements 208 of the contact device 200 corresponds to the number of electrical contact elements that the electrical interface 114 of the battery pack 102 has. The contact elements 208 are connected to the base body 202 of the contact device 200 by hot staking, for example. The four contact elements 208 each have at least one recess 210 for this purpose, in which a hot staking element 212, in particular in the form of a pin of the base body 202 of the contact device 200, engages and which is at least partially melted in the assembly process.

The four contact elements 208 each have a first connection area 214 for connection to a connecting element 216 for connection to the electrical interface 114 of the battery pack 102 and a second connection area 218 for connection to the electronic system 107 of the battery pack 102, in particular for connection to the printed circuit board 109.

The first connection area 214 is arranged as an example on the top side 204 of the contact device 200. The first connection area 214 is exemplarily designed as a flat surface 220 of the contact elements 208. The connecting elements 216 are exemplarily formed as cable elements 222, wherein the cable elements 222 consist, for example, of a copper wire with insulation. The cable elements 222 have different cross-sections, with the cross-sections for the power-transmitting cable elements being larger. In the first connection area 214, the cable elements 222 are in contact with the contact elements 208 without insulation and are connected by way of a material bond, for example by soldering, ultrasonic welding or a crimping method.

The second connection area 218 is, for example, arranged at a distance from the first connection area 214 and, in particular, at an opposite end of the contact elements 208. The contact elements 208 are shaped in such a way that the contact elements 208 extend around the base body 202 of the contact device 200. For example, the contact elements 208 each have two bending edges 224, at which the contact elements 208 are bent by approx. 45°. The bend means that the recesses 210 of the contact elements 208 are arranged laterally and thus in particular between the first connection area 214 and the second connection area 218.

The second connection area 218 of the contact elements 208 has at least one spot weld 226, in particular a single spot weld 226 or two spot welds 226, by way of example. The spot welds 226 are exemplarily designed as hump-shaped elevations. The spot welds 226 are designed to form a material bond between the contact elements 208 and the printed circuit board 109 of the battery pack 102 using a welding method. The contact elements 208 have assembly aids 228 in the form of recesses 230 in the second connection area 218. The assembly aids 228 can be used to ensure that the second connecting areas 218 can be bent over during the assembly process, so that the second connecting areas 218 are arranged on the underside 206 of the contact device 200 after bending, as shown in FIG. 4.

FIG. 4 shows a partial view of the battery pack 102 in perspective, without the housing. The battery cells 130 of the battery pack 102 are accommodated in cell holders 132, which are formed from a plastic and accommodate the battery cells 130 individually, by way of example. The electronic system 107, in particular the printed circuit board 109, of the battery pack 102 is arranged, for example, on an outer side of the cell holder 132 between two battery cells 130.

The printed circuit board 109 has several unspecified electronic components. In addition, the electronic system 107, in particular the printed circuit board 109, is electrically connected to the battery cells 130 via cell connectors 134. The cell connectors 134 are designed in such a way that they are connected to the front of the battery cells 130. In addition, the cell connectors 134 are connected to the circuit board 109 on the side facing away from the battery cells 130. The connection between the printed circuit board 109 and the cell connectors 134 is made by way of a welding method, for example a resistance welding method. The cell connectors 134 are exemplarily welded individually or on top of each other to the printed circuit board 109.

When assembled, the contact device 200 is arranged between the electronic system 107, in particular the printed circuit board 109, the battery pack 102 and the cell holder 132 of the battery pack 102. The contact device 200 is preferably designed such that the contact device can be connected to the cell holder 132 and/or the printed circuit board 109 in a force-fitting and/or form-fitting manner. The second connecting areas 218 are thus bent in the assembly process after the printed circuit board 109 has been mounted, so that they rest against the printed circuit board 109 of the battery pack 102. The second connecting areas 218 of the contact elements 208 are located on the same side of the printed circuit board 109 as the cell connectors 134. This has the advantage that both the electrical contact elements 208 of the contact device 200 and the cell connectors 134 can be electrically connected to the printed circuit board 109 of the battery pack 102 using the same type of connection, for example a resistance welding method.

The contact device 200 has holding elements 232 and guide elements 234 to optimally position and fix the connecting elements 216, in particular the cable elements 222, during assembly. The guide elements 234 are exemplarily designed as partition walls 236, which extend outwards from the base body 202 and are exemplarily of a height which essentially corresponds to a height of the connecting elements 216.

The contact device 200 exemplarily comprises two different holding elements 232. The first holding element 232 is exemplarily formed as a latching clip 238, which is exemplarily formed for the force-fitting fixation of all connecting elements 216. The latching clip 238 has a hinge on one side and a latching lug 240 on the other.

In addition, the contact device 200 exemplarily comprises two second holding elements 232, exemplarily in the form of press fits 242. The second retaining elements are designed for the force-locked fixation of individual connecting elements 216.

What is claimed is:

1. A battery pack, comprising:
an electrical interface configured to detachably connect the battery pack to a consumer;
an electronic system having at least one printed circuit board; and
a contact device which has (i) at least one contact element, and (ii) at least one connecting element,
wherein the at least one contact element is designed to connect the electrical interface to the electronic system, and
wherein the at least one connecting element is designed to electrically connect the at least one contact element to the electrical interface.

2. The battery pack according to claim 1, wherein the contact element has a first connecting area configured for connection to the connecting element and a second connecting area configured for connection to the electronic system.

3. The battery pack according to claim 1, further comprising at least one battery cell and at least one cell connector, wherein:
the battery cell is connected to the electronic system via the cell connector.

4. The battery pack according to claim 3, wherein the contact element and cell connector are connected to the printed circuit board using the same connection technology.

5. The battery pack according to claim 4, wherein the connection technology is designed as a welding method.

6. The battery pack according to claim 3, wherein the contact element and the cell connector are arranged adjacent to one another on the printed circuit board of the electronic system.

7. The battery pack according to claim 1, wherein the at least one contact element is connected in a form-fitting manner to a base body of the contact device.

8. The battery pack according to claim 1, wherein the at least one contact element has an assembly aid which is designed to deform the at least one contact element in the assembly process.

9. The battery pack according to claim 15, wherein the contact device comprises at least one holding element configured to hold the at least one cable element.

10. A contact device for a battery pack, comprising:
at least one contact element which is designed to connect an electrical interface of the battery pack to an electronic system of the battery pack;
at least one holding element; and
at least one cable element,
wherein the at least one contact element is configured to be electrically connected to the electrical interface via at least one cable element, and
wherein the at least one holding element is configured to hold the at least one cable element.

11. The contact device according to claim 10, wherein the holding element is designed as a latching mechanism.

12. The contact device according to claim 10, further comprising:
at least one guide element; and
at least one connecting element,
wherein the at least one guide element is configured to guide the at least one connecting element.

13. The battery pack according to claim 1, wherein the battery pack is a replaceable battery pack.

14. The battery pack according to claim 1, wherein the consumer is an electric bike.

15. The battery pack according to claim 1, wherein the at least one connecting element is at least one cable element.

16. The battery pack according to claim 1, wherein the contact element has a first connecting area configured for connection to the connecting element and a second connecting area configured for connection to the printed circuit board.

17. The battery pack according to claim 5, wherein the welding method is a resistance welding method.
